(19) United States
(12) Patent Application Publication
(10) Pub. No.: US 2022/0321347 A1
(43) Pub. Date: Oct. 6, 2022

(54) SYSTEM, METHOD AND APPARATUS FOR TRANSACTION ACCESS AND SECURITY

(71) Applicant: Andrew Mark, San Jose, CA (US)

(72) Inventor: Andrew Mark, San Jose, CA (US)

(21) Appl. No.: 17/708,840

(22) Filed: Mar. 30, 2022

Related U.S. Application Data
(60) Provisional application No. 63/167,753, filed on Mar. 30, 2021.

(51) Int. Cl. H04L 9/32

(52) U.S. Cl. CPC H04L 9/3213; H04L 9/3263; H04L 9/3231

(57) ABSTRACT

A method and system are provided for generating a verified user identity certificate (VUIC) for use by a security token device. The method can include receiving a user input to initiate creation of the VUIC and generating for display a prompt to authenticate the user via a biometric input at the security token device. The method can include pairing the security token device and the client device. The method can include receiving identity information and sending the identity information to a verification service. The method can include generating the VUIC comprising: a name, date of birth, and social security number. The method can include generating for display a prompt to initiate installation of the VUIC at the security token device. The method can include receiving at least one security key from the security token device and installing the VUIC at a secure enclave of the security token device.

### CROSS-REFERENCE TO RELATED APPLICATIONS

This application claims priority to and benefit of U.S. Provisional Patent Application No. 63/167,753, entitled “SYSTEM, METHOD AND APPARATUS FOR TRANSACTION ACCESS AND SECURITY,” filed on Mar. 30, 2021, the entire contents of which are incorporated herein by reference.

### FIELD OF THE INVENTION

Aspects of the invention relate generally to transaction and access security and, more specifically, the use of a security token device to enable easier, more secure use of credential information.

### BACKGROUND

Security credentials are commonly used to access a variety of systems and services, both through access to the Internet and at physical locations (e.g., financial institutions, offices, schools, merchants, etc.). These security credentials are typically in the form of a user identifier, a passcode, or a personal identification number (PIN), as well as physical security keys like bank/credit cards and radio-frequency identification (RFID) cards. However, these security credentials are vulnerable to exploitation by malicious third parties that seek to acquire unauthorized access to information associated with an individual (e.g., account information, payment information, sensitive personal information, etc.) or an entity associated with the individual (e.g., enterprise computing systems or employer facilities). Additionally, the sheer number of security credentials can be overwhelming for a user to maintain securely and conveniently.

While techniques have been developed and implemented as an attempt to manage security credentials, almost all systems still rely, centrally, on a user-specific “key” (e.g., an identifier/password combination) that grants access to the services and systems associated with the individual. Unfortunately, these keys are commonly fraudulently acquired (e.g., hacked, phished, stolen, or surfed), leading to damages for both the individual and related entities.

As such, a need has been recognized for an improved system to create and manage an individual's security credentials, while allowing the individual to easily present security credential information as necessary. The improved system needs to replace the commonly used identifier/password combination with an enhanced-security biometric solution that is resistant to fraudulent activity by a third-party entity, while also including capabilities for integration with security credentials from several different sources and industries.

### SUMMARY

Disclosed herein are systems, methods, and apparatuses directed to use of a security token device to enable easier, more secure use of credential information (e.g., verified user identity certificates). In one aspect, the disclosure features methods for generating a verified user identity certificate (VUIC) for use by a security token device. The method can include: receiving, at an application of a client device, a user input to initiate creation of the VUIC; generating for display, via the application, a prompt to authenticate the user via a first fingerprint input at the security token device; pairing, based on a first authentication of the first fingerprint input, the security token device and the client device; receiving, at the client device, a user input comprising identity information associated with the user; sending, from the client device, the identity information to a third-party verification service; generating, based on a verification of the identity information, the VUIC, wherein the VUIC comprises: a name, date of birth, and social security number; generating for display, via the application, a prompt to initiate installation of the VUIC at the security token device; receiving, based on a second authentication of a second fingerprint input and a user input authorizing installation of the VUIC at the security token device, at least one security key from the security token device; and installing the VUIC at a secure enclave of the security token device.

Various embodiments of the exemplary method can include one or more of the following features. The method can include generating for display, via the application, one or more requirements to initiate creation of the VUIC. The method can include receiving, at the application of the client device, a user input acknowledging the one or more requirements; and initiating pairing, based on the user input acknowledging the one or more requirements, the security token device and the client device. The generating for display the prompt to authenticate the user via the first fingerprint input at the security token device can be based on the user input acknowledging the one or more requirements. The first authentication of the first fingerprint input can include: receiving, at the security token device, the first fingerprint input; and determining, based on a comparison of the first fingerprint input to a fingerprint template stored by the security token device, the fingerprint template as corresponding to the user. The method can include generating for display, via the application, a prompt for the identity information associated with the user. The identity information associated with the user can include one or more of: user contact information, government-issued identification documentation, and a photo of the user. The method can include receiving, at the client device, confirmation of a receipt of the identity information from the third-party verification service. The method can include receiving, at the application of the client device, contents of the VUIC; and sending, based on a user input accepting the contents of the VUIC, the user input authorizing installation of the VUIC at the security token device. The method can include receiving, from a certificate authority via the client device, the VUIC.

Other embodiments of this aspect include corresponding systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1 shows an illustration of exemplary security token devices, in accordance with some embodiments;

FIG. 2 shows an illustration of an exemplary system including a security token device, in accordance with some embodiments;

FIG. 3 shows an illustration of an exemplary security token device database, in accordance with some embodiments;

FIG. 4 shows an exemplary sequence for initializing a security token device, in accordance with some embodiments;

FIG. 5 shows an exemplary sequence for initializing facial authentication for a security token device, in accordance with some embodiments;

FIG. 6 shows an exemplary sequence for initializing voice authentication for a security token device, in accordance with some embodiments;

FIG. 7A shows an exemplary sequence for creating a verified user identity certificate, in accordance with some embodiments;

FIG. 7B shows an exemplary sequence for installing a verified user identity certificate, in accordance with some embodiments;

FIG. 8 shows an exemplary sequence for creating an affiliate certificate, in accordance with some embodiments;

FIG. 9 shows an exemplary sequence for creating a payment certificate, in accordance with some embodiments;

FIG. 10 shows an exemplary sequence for initial usage of a security token device, in accordance with some embodiments;

FIG. 11 shows an exemplary sequence for return usage of a security token device, in accordance with some embodiments;

FIG. 12 shows an illustration of an exemplary system for using a verified user identity certificate, in accordance with some embodiments;

FIG. 13 shows a glossary corresponding to the security token device, in accordance with some embodiments;

### DETAILED DESCRIPTION

To address the shortcomings of current techniques, a credentialing system and methods that integrate, for example, a radio-frequency (RF)-based user device and one or more biometrics, verified user identity digital certificates and public key infrastructure (PKI) are described herein. In various embodiments, the invention makes use of wireless identity security token (“WIST”) technology, integrating a wireless identity security token device (“VeriKey” or “WIST device”) with a WIST client application (“VCS”) installed/operating at a computing device (“client device”) associated with an individual to provide enhanced security and privacy for the individual's security credentials. The invention makes use of digital certificates (e.g., user-identity certificates, payment certificates, or affiliate certificates) that are created and verified by trusted entities, where the digital certificates are securely maintained (e.g., subject to 128-bit encryption) using the VeriKey under biometric authentication methods. In certain embodiments, all user data including data representing biometrics and certificates is stored separately from the authentication processing to enhance security. In some cases, the certificates are created based in part on user ID information, copies of identification cards, photos, biometrics, and other user-specific components, stored in a central certificate database and transmitted to user devices on demand. The digital certificates can be transmitted wirelessly (e.g., between the VeriKey and client device) over encrypted communication methods as described herein.

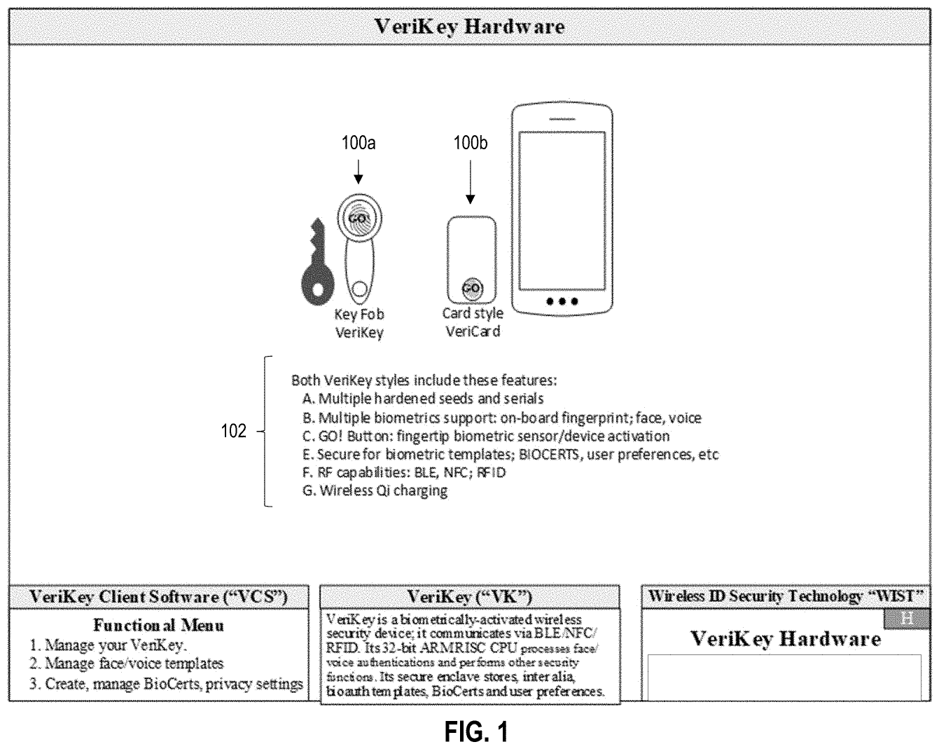

FIG. 1 shows an illustration of exemplary security token devices 100 (referred to as security token devices 100a and 100b), in accordance with some embodiments. In some embodiments, as shown in FIG. 1, the security token device 100 can be a “key fob” (referred to as a “VeriKey”) security token device 100a. In some embodiments, the security token device 100 can be a “card” (referred to as a “VeriKey” or “VeriCard”) security token device 100b. The security token device 100 can include a processor and one or more memory devices as described herein. In some cases, the security token device can include one or more features 102 shown by FIG. 1. The VeriKey can include one or more input devices that are exclusively controlled by the device owner (e.g., a Go! button input as shown in FIG. 1) to activate the device's biometric capture feature and receive input from the user, authenticate the user, and if authenticated, enable the remaining features of the device. The VeriKey can include one or more biometric sensors, including, for example, a fingerprint sensor and/or a vein sensor, to secure access to security credentials at a connected client device (e.g., a mobile phone, tablet, or personal computer). Biometric acquisition capabilities available at the client device (e.g., facial recognition, voice recognition, etc.) can, in conjunction with the VeriKey, further grant access and/or allow use of security credentials stored by the VeriKey (if configured by a user). In some cases, security credentials may be stored at a secure enclave of the VeriKey and/or at a secure enclave of a connected client device, such that the security and convenience benefits of the security credentials can be used in any application including a secure enclave. The VeriKey can apply a minimum certainty threshold for biometric authentication methods. For example, the certainty of a received biometric input in comparison to a stored biometric entry (e.g., a biometric authentication template) must meet or exceed the minimum certainty threshold to grant access to information stored at the VeriKey. A secure enclave (e.g., a secure processor and memory combination) may store and manage the sensitive information stored at the VeriKey, including, for example, biometric information, public/private keys, and digital certificates. The VeriKey can include one or more communication systems (e.g., antennas, tags, etc.) to enable radio-frequency (RF) communications with the client device with which it is associated (in some instances uniquely). For example, the VeriKey can include communication systems to communicate via Bluetooth low energy (BLE), near-field communication (NFC), and RFID communication methods. In some cases, the VeriKey can include a microphone to enable acoustic activation (e.g., start-up) of the VeriKey. For example, based on detecting an acoustic wake-up signal (e.g., a high-frequency acoustic signal, dual-tone acoustic signal, etc.) via the microphone, the VeriKey may activate an onboard power system (e.g., a battery) to power the VeriKey. In some cases, a client device may generate the acoustic wake-up signal used to activate the VeriKey. As an example, the acoustic wake-up signal may include signal(s) of up to approximately 4 kHz.

In some embodiments where battery life and power usage is an important factor, the battery will power the biometric circuit under two different conditions: (a) when the GO! button and a 2nd switch (e.g., on the side of the device) are shorted, or (b) when two different frequencies (for example, one ˜20 k; the other ˜300 hz) are sensed by coils at approximately the same level. As both tones will last no longer than 40 ms, they are both imperceptible to the human ear. Otherwise, the device remains in sleep mode to extend the battery life for months or even years.

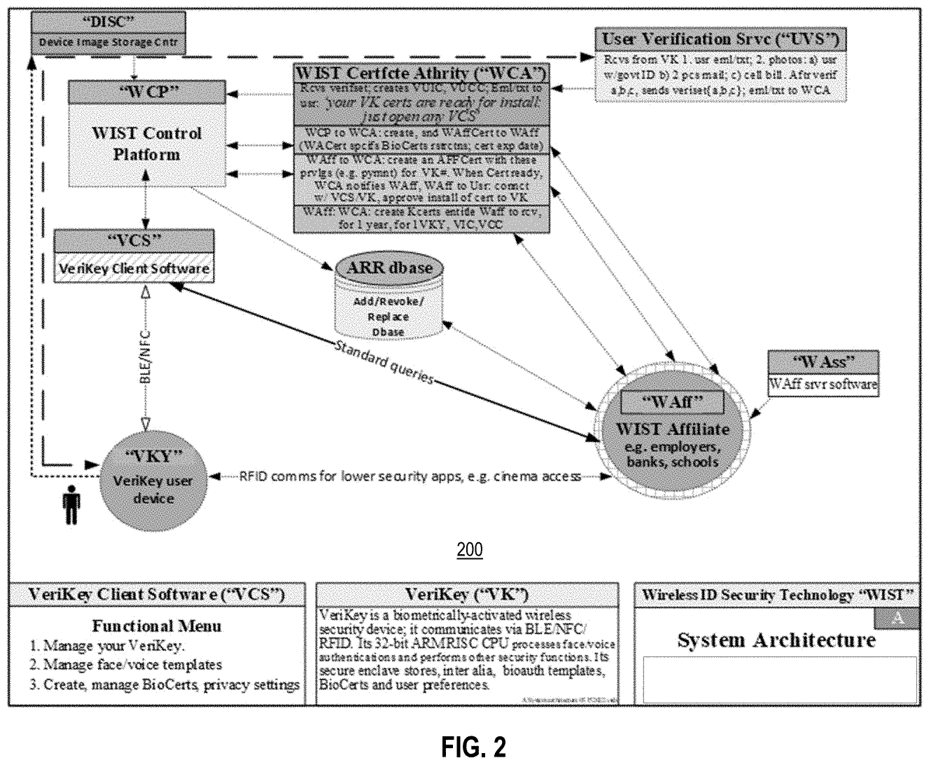

FIG. 2 shows an illustration of an exemplary system 200 including a security token device, in accordance with some embodiments. In some embodiments, as shown in FIG. 2, the system 200 may include a security token device (referred to as a “VeriKey”, “VeriKey user device”, and/or “VKY”). The security token device may correspond to and/or otherwise include feature(s) of the security token device 100a as described herein. In some cases, the security token device may communicate with VeriKey Client Software (referred to as “VCS” or “client software”) and WIST affiliates (referred to as “WAff” or “WAffs”). As an example, WAffs can include employers, insurance providers, financial institutions, educational institutions, merchants, government entities, licensing boards, and any other entity that may issue a digital certificate for use by the VeriKey and/or enable use of information stored by the VeriKey. Each WAff may correspond to respective WAff server software (referred to as “WAss”) hosted by one or more computing devices. The WAss corresponding to each WAff may enable the WAff to communicative and interface with the services and systems as shown in FIG. 2 and as described below.

In some embodiments, the VeriKey may communicate with WAffs using one or more of BLE, NFC, and/or RFID as described herein. For example, a user may present the VeriKey at a point-of-sale (POS) terminal, where the VeriKey communicates payment information from a payment certificate using NFC communications.

Using the VCS (e.g., installed and/or included at a client device), a user can manage their VeriKey, including activating the VeriKey, configuring biometric access methods (e.g., fingerprint, vein, facial, or voice recognition), managing digital certificates, and configuring user settings (e.g., privacy preferences, localization preferences, etc.). The client device (that includes an active, installed VCS and BLE) can interface with the VeriKey using, for example, BLE communication methods. A user can control and/or configure the VeriKey using a VCS installed at any client device associated with the user. The VCS can enable communications between the VeriKey and a WIST control platform (“WCP”), WAffs, and verification services for the VeriKey.

In some embodiments, as shown in FIG. 2, a WCP can operate on one or more servers as a control platform for each VeriKey and related systems associated with affiliate entities (e.g., WAffs). The WCP may include one or more databases including information associated with users, VeriKeys, and/or WAffs. In some cases, the WCP may include and/or be communicatively connected to a device image storage center (referred to as a “DISC”). The DISC may include information identifying each VeriKey and/or user of each VeriKey. For example, information stored by the DISC that identifies each VeriKey and/or user of each VeriKey may be used to activate a new (or replacement) VeriKey. In some cases, the WCP may include and/or be communicatively connected to an add/revoke/replace (referred to as “ARR” database), where the ARR database provides an indication of particular digital certificates that have been revoked by one or more WAffs. For example, the ARR database may store indications of digital certificates corresponding to respective VeriKeys that should be accepted by WAffs, where the WCP may add, revoke, and/or replace indications of digital certificates stored by the ARR database. In some cases, the WAffs may interface and/or otherwise communicate with the ARR database to identify digital certificates that should be accepted as credentials. In some cases, WAss corresponding to a WAff may retrieve a copy of information stored by the ARR database and may periodically retrieve updates from the ARR database to maintain the copied information For example, a WAff may retrieve digital certificate information from the ARR database periodically and/or based on attempted use of the VeriKey (and associated digital certificates) for access privileges with the WAff.

In some embodiments, The WCP can enable activation of a VeriKey via a client device, where the client device communicates identifying information (e.g., serial numbers, security keys, or biometric information) for the VeriKey (and the user of the VeriKey) to the WCP as described herein.

In some cases, the WCP can cause revocation and/or suspension of use of a VeriKey. For example, a user can indicate to the WCP (e.g., via the VCS installed at a client device) and/or the DISC that their VeriKey is missing, which can result in the WCP and/or the DISC suspending use of the VeriKey as a secure credential device (e.g., by revoking the VeriKeys digital certificates from the ARR database). The WCP can authorize one or more verification services to verify user-provided information (photos, docs_) that establish their claimed identity and contact information. enable creation and verification of digital certificates stored at the VeriKey. As shown in FIG. 2, the WCP can communicate with a user data verification service (referred to as “UVS”), for example, where the WCP communicates user information received from the VCS (and VeriKey) to the UVS for authentication purposes. The WCP can communicate with one or more WIST certificate authorities (referred to as “WCA”, “WCAs”, “CA”, or “CAs”) to configure digital certificates for the VeriKey. The WCP can configure a WAff's access to a user's information stored in digital certificates of the VeriKey. In some cases, the WCP may communicate with the WAff systems to manage the digital certificates (e.g., affiliate certificates) associated with each WAff. For example, an educational institution may issue a digital certificate indicating a user's completion of a degree program by communicating the digital certificate to the WCP. The WCP may send the digital certificate to the client device (and VCS) associated with the user, where the client device communicates the digital certificate to the VeriKey securely using BLE.

In some embodiments, as shown in FIG. 2, the UVS can communicate with the WCP and the WCA. The UVS can serve as a verification service for personal information provided by a user during activation/initialization of a VeriKey. The UVS may receive and verify the personal information from the WCP, where a user provided the personal information to the WCP via the VCS at a client device. In some cases, the UVS can operate on a combination of server devices and/or personal computing devices to verify personal information provided by a user. For example, the UVS may automatically execute a background check for a user (based on the personal information provided by the user). The UVS may compare the results of the background check with the personal information to verify the authenticity of the personal information. Additionally, for example, an operator of the UVS may manually verify the personal information. Based on verifying the personal information, the UVS may communicate to the WCP that the personal information is authentic.

In some embodiments, as shown in FIG. 2, the WCA can communicate with the WCP, UVS, and systems (e.g., WAss) associated with the WAffs. The WCA is the certificate authority for issuing digital certificates that are stored at the VeriKey. In some cases, the WCA can be included in the WCP. As described herein, the WCA, acting in a ministerial role, can grant, modify, and/or otherwise revoke certificates from the VeriKey and from WAffs that issue affiliate certificates for use by VeriKeys. For example, as described below, the WCA can create a verified user identity certificate (“VUIC”) based on verification personal information associated with a user which incorporates user identity information that was provided by the user and verified by UVS. The VUIC may be biometrically-activated and/or biometrically-controlled using the VeriKey and/or a connected client device including VCS. Based on creation of the VUIC, the WCA can send the VUIC to the WCP for further transmission to the VCS and associated VeriKey. In some cases, the can receive instructions from a WAff (via the WCP) to revoke an affiliate certificate for a particular user of a VeriKey. For example, an employer can issue a digital certificate to an employee for use as a key to an employer facility (e.g., an office, warehouse, etc.). Based on termination of the employee, the employer can communicate to the WCA to revoke the employee's digital certificate (and corresponding access privileges to the employer facility).

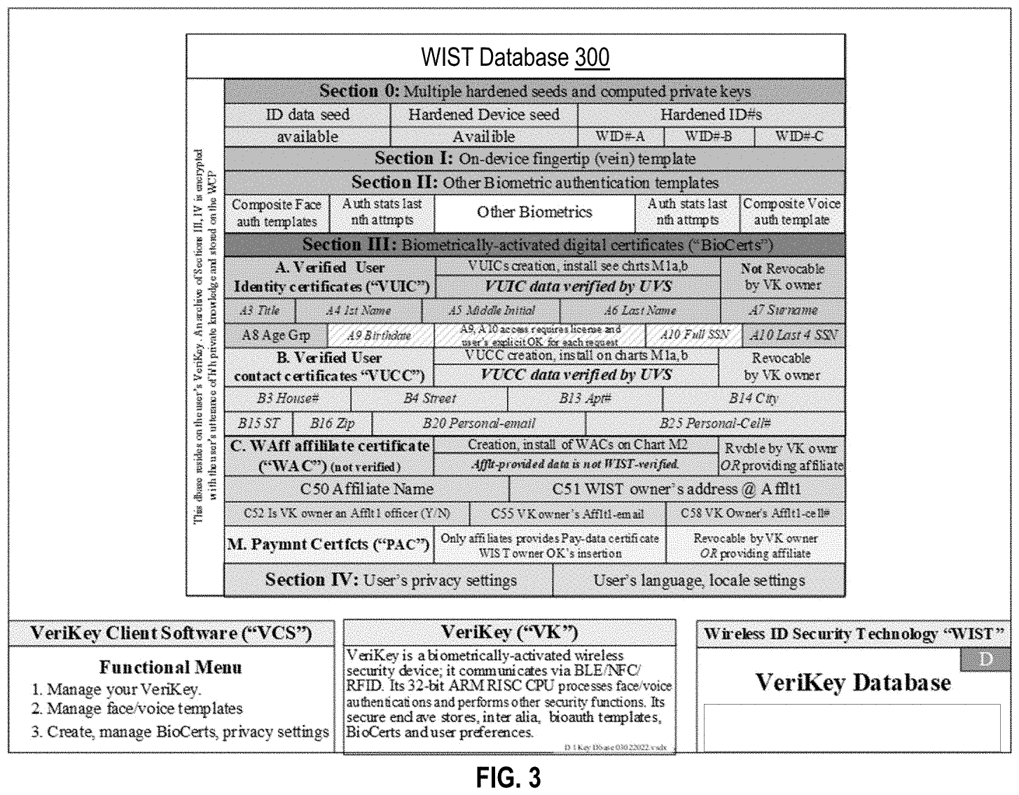

FIG. 3 shows an illustration of an exemplary WIST database 300, in accordance with some embodiments. In some embodiments, a VeriKey may include one or more databases to store sensitive information (e.g., digital certificates, biometric information, etc.). As shown in FIG. 3, a WIST database 300 located on a memory device (e.g., a secure memory device of a secure enclave) of the VeriKey may store information with varying levels of security. Based on the varied security levels, a user and/or WAffs may have varied access privileges to view and/or modify stored information. In some cases, as shown in FIG. 3, the WIST Database 300 may include multiple hardened seeds and/or private keys (as in Section 0). The hardened seeds and/or private keys may include an identifier (“ID”) data seed associated with the user, ID-related private key(s), VeriKey device data seed(s), VeriKey device private key(s), and/or one or more other hardened identifiers (e.g., WISTID #-A, WISTID #-B, WISTID #-C, etc.). These hardened seeds and/or private keys may be used to enable secure communications (e.g., with the VCS and/or WCP), as well as for identification of the user and the VeriKey.

In some embodiments, as shown in FIG. 3, the WIST database 300 may include one or more on-device biometric templates (as in Section I). As an example, the biometric template(s) can include a fingerprint authentication template and/or or a vein authentication template. In some cases, the biometric template(s) may define configuration parameters for received biometric security information. For example, a fingerprint scanner of the VeriKey may scan a user fingerprint as described herein according to the parameters of the fingerprint authentication template. Additionally, in some cases, the biometric template(s) may include a stored representation/reference of a user's biometric information. For example, a user's fingerprint information may be stored as a fingerprint template to authenticate a fingerprint during subsequent biometric input attempts. The VeriKey may compare the fingerprint template to the received biometric input and may authenticate the received biometric input based on a minimum certainty threshold as described herein.

In some cases, as shown in FIG. 3, the WIST database 300 may include one or more other biometric templates (as in Section II). The biometric templates may be associated with biometric authentication inputs received via the VCS of a client device. As an example, the biometric template may be a facial authentication template, where the facial authentication template can be generated based on a user's facial recognition information that is captured by a sensor (e.g., a camera, infrared sensor, dot projector, etc.) of the client device. For example, the VCS may prompt the user to present their face from one or more angles, such that the VCS can recognize the user's facial features. As another example, the biometric template may be a voice authentication template, where the voice authentication template can be generated based on a voice input to a microphone of the client device according to one or more input parameters. For example, the VCS may prompt the user to speak one or more phonetically rich phrases, such that the VCS can provide the input to the VeriKey which in turn uses that input to accurately identify the user's voice characteristics, cadence, and/or frequency range. The WIST database 300 may store statistics associated with biometric inputs to the VeriKey or the VCS. For example, the WIST database 300 may store recent biometric authentication attempts and/or the number of failed biometric authentication attempts.

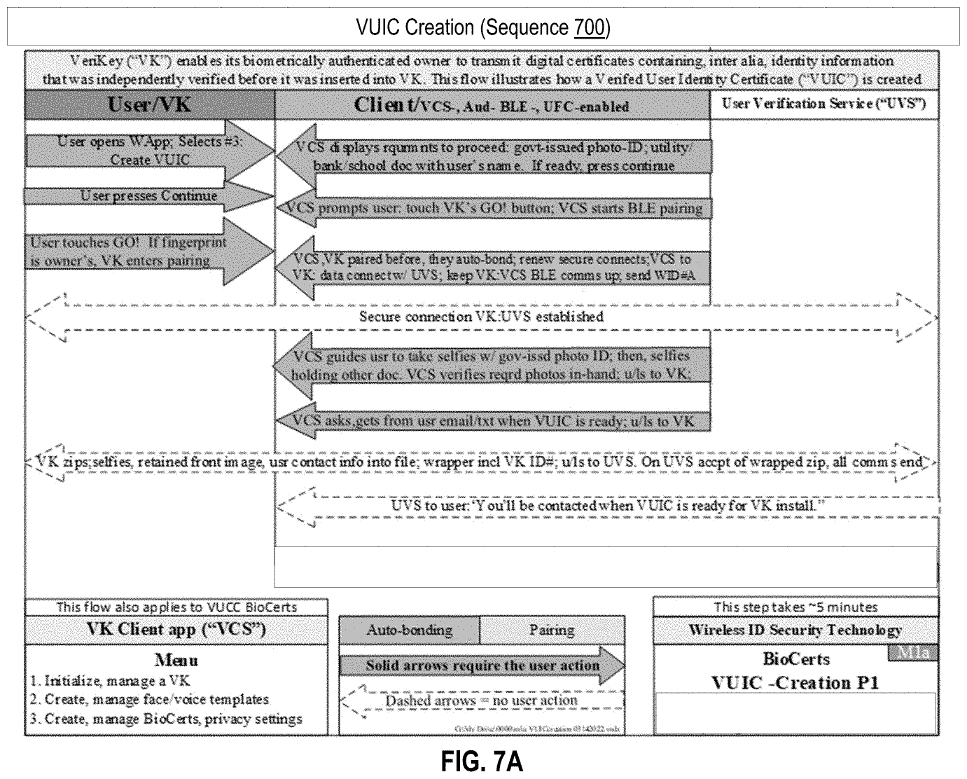

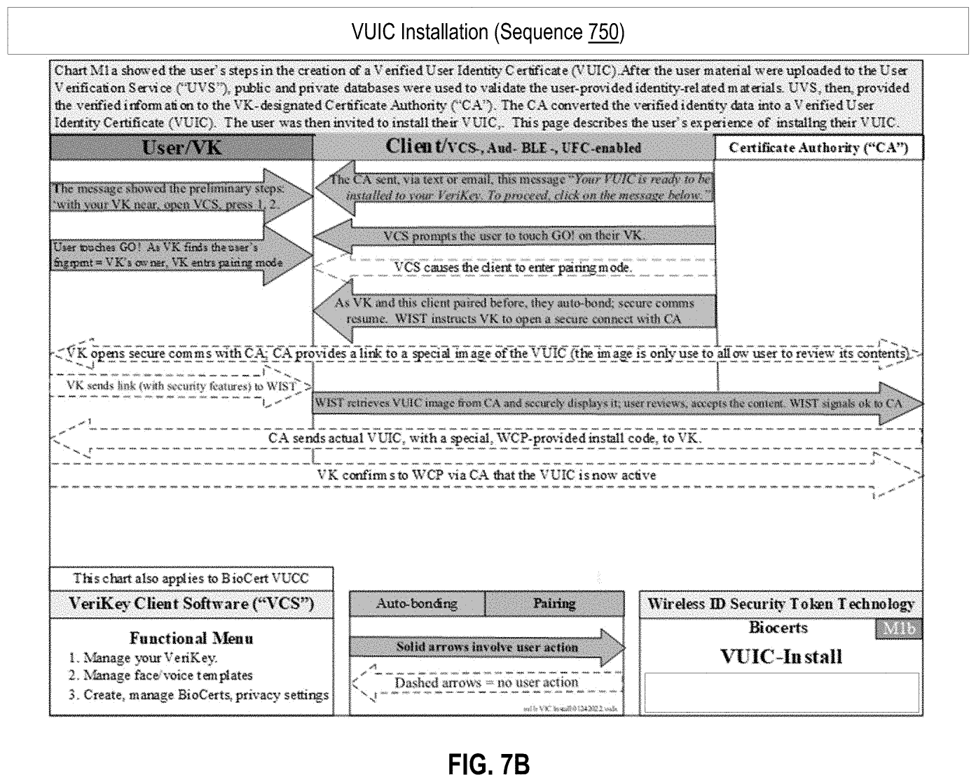

In some cases, as shown in FIG. 3, the WIST database 300 can include one or more biometrically-activated digital certificates (as in Section III). The biometrically-activated certificates may include a VUIC that is created upon validation of the user information by the UVS as further described herein. In some cases, the VUIC may be restricted to modification by a user without additional verification from the UVS. As shown in FIG. 3, the VUIC may include title, first name, middle name, last name, surname, age, birthdate, and/or social security number (or other government-issued identifiers) for a user of the VeriKey. Certain fields of the VUIC, such as social security number, may be hidden from view, truncated, obfuscated and/or access restricted based on user permission. In some cases, the biometrically-activated certificates may include a verified user contact certificate (“VUCC”). The VUCC may be created and/or verified (e.g., by the UVS) according to one or more features of a method for creating and/or verifying the VUIC as described herein with respect to FIGS. 7A and 7B. The VUCC may operate as the biocertification module related to the VUIC-identified contact information. The VUCC may include address information for the user. For example, apartment number, city, state/province, and/or zip code associated with the user of the VeriKey. In some cases, the VUCC may include contact information for the user. For example, as shown in FIG. 3, the VUCC can include an email address and phone number information for the user.

In some cases, as shown in FIG. 3, the biometrically activated certificates may include one or more affiliate certificates. An affiliate certificate (referred to as “Acert”, “WAff affiliate certificate”, “WAC”, or “WACs”) may include information for a user's relationship with a WAff. A WAC may be a digital certificate issued by a WAff as described herein. A WAC may be revocable by a user and/or by the issuer of the WAC (e.g., a WAff such as an employer, government agency, etc.). A WAC can include a name of a WAff, an address of the WAff, an address for a user associated with the WAff, information indicating the user's relationship with the WAff (e.g., title within an organization), an email address associated with the WAff, and/or a phone number associated with the WAff. As an example, a WAC can be an education certificate issued by an educational institution that includes a name of the institution, an address of the institution, a completion date (e.g., a graduation date) for the user, and/or an education program (e.g., a degree program) for the user. As another example, a WAC can be a license (e.g., medical license, contractor license, driver's license, legal license, etc.) that includes the issuer of the license and/or a license identifier for the user. In some cases, the biometrically-activated certificates may include one or more payment certificates (referred to as “PAC”, “PACs”, “PCert”, or “PCerts”). Similar to affiliation biometric certificates, a PAC may be revocable by a user and/or by the issuer of the payment certificate. A PAC may include bank account information (e.g., account number, routing number, card number, PIN, etc.) and other financial information (e.g., credit accounts) associated with a user. The PAC may be used as a form of payment via the VeriKey, for example, at a POS terminal of a merchant.

In some cases, as shown in FIG. 3, the WIST database 300 can include privacy settings (as in Section IV). The privacy settings may include user preferences for WAff access to the biometrically activated digital certificates. A user may configure the privacy settings using the VCS. For example, a user may grant a first WAff access to the user's name, age, email address, and phone number in the VUIC and VUCC, but the user may grant a second WAff access to only the user's name. In some cases, the privacy settings may include language and location settings. For example, based on a user's locale, location, the access to the one or more biometrically-activated digital certificates may vary. In some cases, the privacy settings can include user-specified authorizations for the WAff related to personal information, such as specific biometric certifications. In other cases, the user may specify that their purchase history with a particular WAff cannot be sold to a third party.

### VeriKey Activation

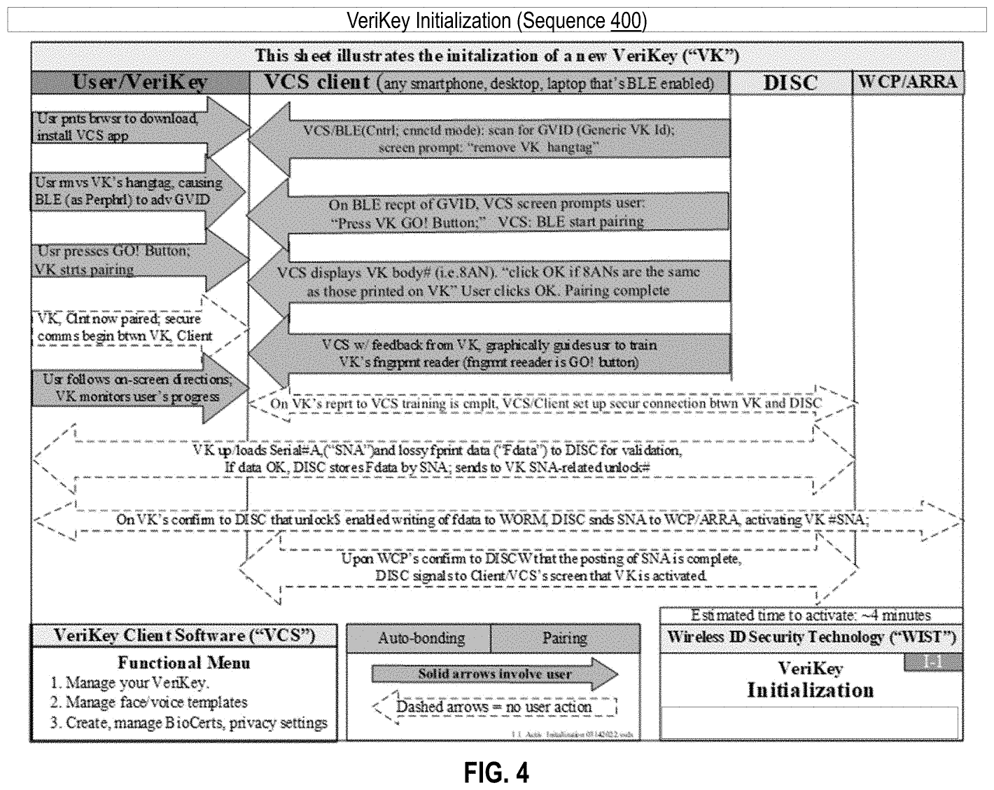

FIG. 4 shows an exemplary sequence 400 for initializing a security token device, in accordance with some embodiments. In some embodiments, as shown in FIG. 4, the VeriKey may be initialized and/or activated via the VCS by an activation method (e.g., sequence 400). The sequence 400 may include communication between the VeriKey, user, client device including the VCS, DISC, WCP, and ARR database. As shown in the sequence 400, a user may download the VCS to a client device (e.g., mobile phone, tablet, PC, etc.). The user may download the VCS via a web browser and/or an application distribution platform. Based on downloading the VCS, the VCS may determine whether BLE is enabled at the client device. For example, upon the installation of the VCS, it first looks to see if BLE is installed and currently active. If BLE cannot be activated, activation ends. If BLE is present and enabled, VCS actively guides the user. Initially, the user calls up the VCS module relating to initialization

client device scans for a Verikey that the VeriKey. Based on detecting the VeriKey, the VCS may display a prompt to provide an input (e.g., press a Go! button) of the VeriKey. A user may provide an input at the VeriKey, initiating pairing between the VeriKey and the client device. Based on initiating pairing, the VCS may display a prompt to provide one or more inputs. For example, the VCS may display a prompt to input fingerprint information at a fingerprint sensor of the VeriKey. Additionally, for example, the VCS may display a confirmation that an identifier (e.g., a number) displayed by the VCS corresponds to a number associated with the VeriKey. Based on receiving the one or more inputs as described herein, the VCS may establish communications (e.g., a Secure Sockets Layer (“SSL”) connection) with the WCP and/or the DISC via a network to confirm activation of the VeriKey. The VCS may send an identifier associated with the VeriKey to the WCP and/or the DISC. The WCP and/or the DISC may confirm receipt of the identifier and send an identifier (e.g., activation code) to the VCS. The VCS may receive the activation code and may send the activation code to the VeriKey. The VeriKey may receive the activation code and may confirm activation of the VeriKey to the VCS and/or WCP, completing initialization of the VeriKey. The sequence 400 may include any suitable combinations of steps as described herein and shown with respect to FIG. 4.

### Facial Authentication

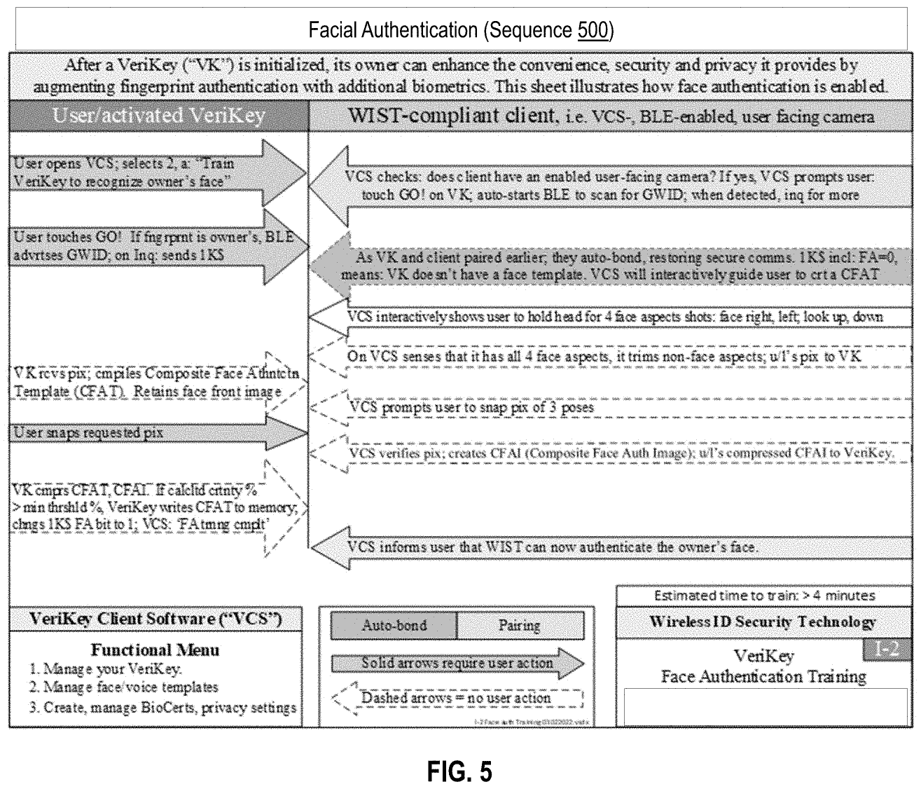

FIG. 5 shows an exemplary sequence 500 for initializing facial authentication for a security token device, in accordance with some embodiments. The sequence 500 may include communication between the VeriKey, user, and client device including the VCS. The sequence 500 may enable a user of a VeriKey to use facial authentication techniques to use and manage digital certificates stored by the VeriKey and/or a connected client device. In some embodiments, as shown in FIG. 5, facial authentication for the VeriKey may be initialized and/or activated via the VCS by an activation method (e.g., sequence 500). At the VCS, a user may provide an input to begin initializing facial authentication. The VCS may determine whether the client device includes a sensor device (e.g., a user-facing camera, etc.) to capture a user's facial profile. Based upon a determination that the client device includes a sensor device (e.g., a camera with sufficient resolution), the VCS may prompt a user to provide an input at the VeriKey to establish secure communications (e.g., via BLE) between the client device and the VeriKey. In some cases, the VCS may prompt the user to provide a biometric (e.g., fingerprint and/or vein) input at the VeriKey (e.g., using the Go! button) to establish communications between the client device and VeriKey. Based on establishing secure communications, the VCS may display instructions for providing facial recognition information via the client device. For example, the VCS may prompt a user to rotate their face and/or provide one or more views of their face in view of the sensor device. The sensor device of the client device may capture the user's facial recognition information. The client device may send the facial recognition information to the VeriKey. Based on receiving the facial recognition information, the VeriKey may generate a facial authentication template. The VeriKey may generate the facial authentication template based on using artificial intelligence techniques to filter nonessential information from the captured facial recognition information. Based on generating the facial authentication template, the VCS may display instructions for a user to provide one or more facial recognition inputs via the client device. The user may capture one or more facial recognition inputs via the sensor device of the client device. Based on receiving the input from the user, the VCS may send the input to the VeriKey for comparison with the facial recognition template. The VeriKey may receive the input and analyze the input based on comparing the input with the generated facial recognition template using a minimum certainty threshold. If the minimum certainty threshold is met or exceeded, the VeriKey may store the facial authentication template in the WIST database and may send a confirmation to the VCS to confirm completion of facial recognition activation method. The sequence 500 may include any suitable combinations of steps as described herein and shown with respect to FIG. 5.

### Voice Authentication

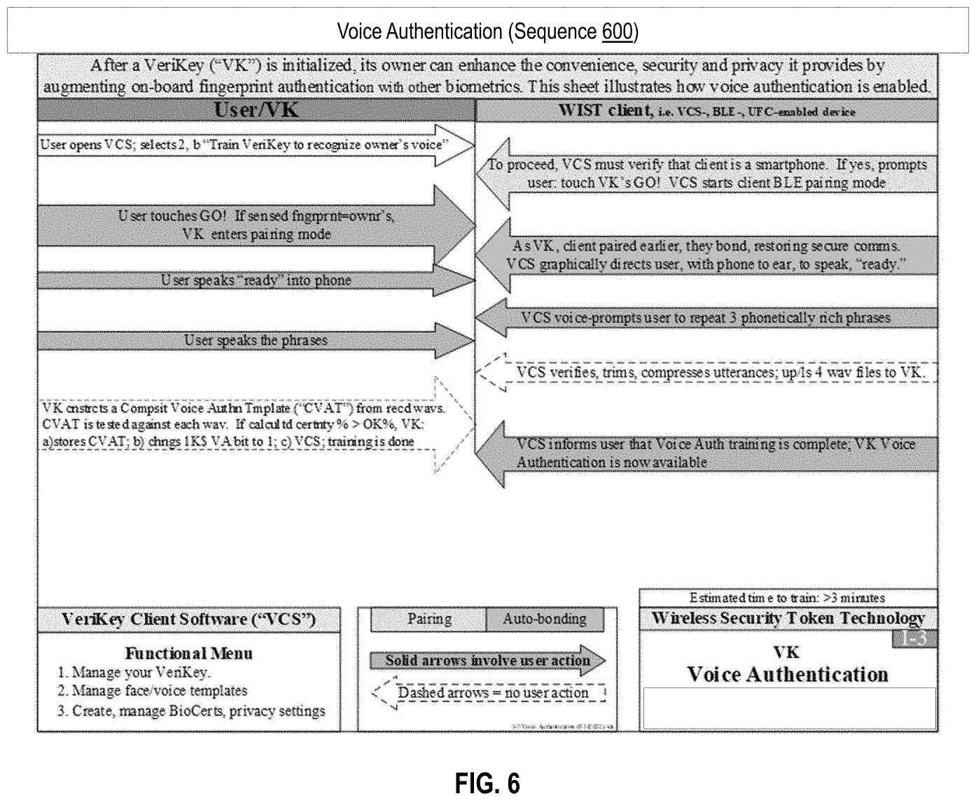

FIG. 6 shows an exemplary sequence 600 for initializing voice authentication for a security token device, in accordance with some embodiments. In some embodiments, as shown in FIG. 6, voice authentication for the VeriKey may be initialized and/or activated via the VCS by an activation method (e.g., sequence 600). The sequence 600 may include communication between the VeriKey, user, and client device including the VCS. At the VCS, a user may provide an input to begin initializing voice authentication (e.g., to train the VCS to recognize the user's voice). The VCS may determine whether the client device includes a microphone device to capture a user's voice characteristics. Based on determining that the client device include a microphone, the VCS may prompt a user to provide an input at the VeriKey to establish secure communications between the client device and the VeriKey. Based on establishing secure communications, the VCS may display instructions for providing voice recognition information via the client device. For example, the VCS may prompt a user to speak “Ready” and one or more phrases. The one or more phrases may be phonetically rich phrases such that the microphone can detect the wide range of a user's voice characteristics. The one or more phrases may be knowledge-based phrases, such that the user is requested to input an answer to a question provided by the VCS. The sensor device of the client device may capture the user's voice recognition information. The client device may send the voice recognition information to the VeriKey. Based on receiving the voice recognition information, the VeriKey may generate a voice authentication template. The VeriKey may generate the voice authentication template based on using artificial intelligence techniques to filter nonessential information (e.g., noise) from the captured voice recognition information. Based on generating the voice authentication template, the VCS may compare the received voice recognition information to the generated voice recognition template using a minimum certainty threshold. If the minimum certainty threshold is met or exceeded, the VeriKey may store the voice authentication template in the WIST database and may send a confirmation to the VCS to confirm completion of voice recognition activation method. The sequence 600 may include any suitable combinations of steps as described herein and shown with respect to FIG. 6.

### Verified User Identity Certificate Creation and Installation

FIG. 7A shows an exemplary sequence 700 for creating a verified user identity certificate, in accordance with some embodiments. The sequence 700 may include communication between the VeriKey, user, client device including the VCS, UVS, and WCP. In some embodiments, as shown in FIGS. 7A and 7B, creation of one or more VUICs for storage and/or use by the VeriKey may occur by a VUIC generation method (e.g., as a combination of the sequences 700 and 750). As shown in FIG. 7A as a part of the sequence 700, at the VCS, a user may provide an input to begin creation/generation of a VUIC. For example, the user may provide an input at the VCS of the client device to create the VUIC. The VCS may display a prompt for a user to provide an input at the VeriKey and may display a prompt for one or more requirements needed for creating the VUIC. The user may provide an input at the VCS. Based on the user providing the input at the VCS, the VCS may display a prompt verify the identity of the user via one or more biometric methods as described herein. Based on the user providing the input at the VCS, the VCS may initiate pairing between the client device and the VeriKey to establish secure communications (e.g., via BLE). The user may input fingerprint information (or other biometric information) at the VeriKey (e.g., via the Go! button). The VeriKey may compare the received fingerprint (or other biometric) information to the stored fingerprint (or other biometric) authentication template. If the received fingerprint (or biometric) information meets or exceeds the minimum certainty threshold for the comparison to the fingerprint (or other biometric) authentication template, the VeriKey may initiate pairing between the VeriKey and the client device. Based on initiating the pairing, the VeriKey and the VCS may establish secure communications and may be communicatively connected. Based on the VeriKey and VCS establishing a secure connection, the VCS may display one or more instructions (e.g., received at the client device from the UVS). The instructions may include one or more prompts for a user to submit identifying information, including, for example, a contact information form, photo(s) of issued government-issued photo-bearing identification documents (e.g., passport, driver's license, etc.), and/or a photo of the user including (e.g., holding) the government-issued identification documents (e.g., by the user showing the identification documents in the photo). The VCS may display the instructions received from the UVS. The user may provide one or more inputs at the VCS to submit the identifying information according to the prompts displayed at the VCS. In some cases, the identifying information may include contact information for the user. Some non-limiting examples of contact information for the user include a phone number and email address. The VCS may send the received identifying information and/or an identifier corresponding to the VeriKey to the UVS. The UVS may confirm receipt of the identifying information and send a confirmation message to the VCS for display at the client device. As an example, the confirmation message may include a notice confirming the user will be contacted (e.g., by the WCA) when the identifying information has been verified and when the VUIC has been generated (e.g., by the WCA) for installation at the VeriKey. The UVS may verify the received identifying information using one or more public and/or private databases. Based on verifying the identifying information, the UVS may send the verified identifying information to the WCA. Based on receiving the verified identifying information from the UVS, the WCA may generate the VUIC corresponding to the user.

FIG. 7B shows an exemplary sequence 750 for installing a verified user identity certificate, in accordance with some embodiments. The steps included in the sequence 750 may proceed after the steps of the sequence 700. The sequence 750 may include communication between the VeriKey, user, client device including the VCS, UVS, WCP, and WCA. As shown in FIG. 7B, as apart the sequence 750 and after verification of the identifying information provided by the user by the UVS and generation of the VUIC by the WCA, the WCA may send a message for display at the client device via the VCS. The message may indicate that the VUIC has been generated and is ready for download to the VeriKey. The message may include a prompt for the user to provide input at the VCS to initiate download of the VUIC from the WCA. The VCS may display the message from the WCA. The user may provide an input at the VCS to initiate download of the VUIC to the VeriKey. Based on receiving the input at the client device, the VCS may display a prompt for the user to provide a biometric input (e.g., fingerprint or other biometric information) at the VeriKey and may initiate pairing between the VeriKey and the client device. The user may input fingerprint information (or other biometric information) at the VeriKey. The VeriKey may compare the received fingerprint information to the stored fingerprint authentication template. If the received fingerprint information meets or exceeds the minimum certainty threshold for the comparison to the fingerprint authentication template, the VCS may establish secure communications with the VeriKey and the WCA. In some cases, the VCS may communicate with the WCA. After secure communications are established, using public/private keys, the WCA and VeriKey may authenticate each other (e.g., via a handshake protocol). For example, based on an authentication of a biometric input, the VeriKey may send one or more security keys to the VCS and/or WCA. The WCA may send a link for a WCA webpage to the VCS, such that the VCS may display the content of the VUIC at the VCS. The VCS may display a prompt for a user to install the VUIC. The user may provide an input at the VCS to grant the WCA access to install the VUIC at the VeriKey (e.g., via the VCS on the client device). Based on received input from the user, the WCA may send the user-authorized certificate (e.g., biometrically-activated and/or biometrically-controlled VUIC) to the VeriKey for installation into the WIST database (e.g., in a secure enclave of the VeriKey. Based on installation of the VUIC, the VeriKey may send a confirmation message to the WCP (e.g., via the VCS and WCA) to indicate that installation is complete. Based on receipt of the confirmation message from the VeriKey, the WCP may display an indication at the client device that the VUIC (and/or the VUCC is available for use). The sequences 700 and 750 may be used for creating and installing a VUCC as described herein. The sequence 750 may be used for installing a WAC and a PAC as described herein. The sequences 700 and 750 may include any suitable combination of steps as described herein and shown with respect to FIGS. 7A and 7B. In some cases, the sequences 700 and 750 may proceed without the use of the VeriKey, such that created/generated VUICs and/or VUCCs are stored for use in a secure enclave of the client device. In some cases, for use of a VUIC or VUCC without a VeriKey, a user may use one or more biometric authentication techniques (e.g., facial and/or voice authentication techniques) corresponding to the client device as a part of the sequences 700 and 750. For example, fingerprint authentication steps of the sequences 700 and 750 corresponding to the VeriKey may correspond to biometric authentication (e.g., facial and/or voice authentication) steps at the client device. If a VUIC or VUCC is created and installed at a secure enclave of a client device, the respective VUIC or VUCC may only be used with the client device.

### Affiliate Certificate Creation

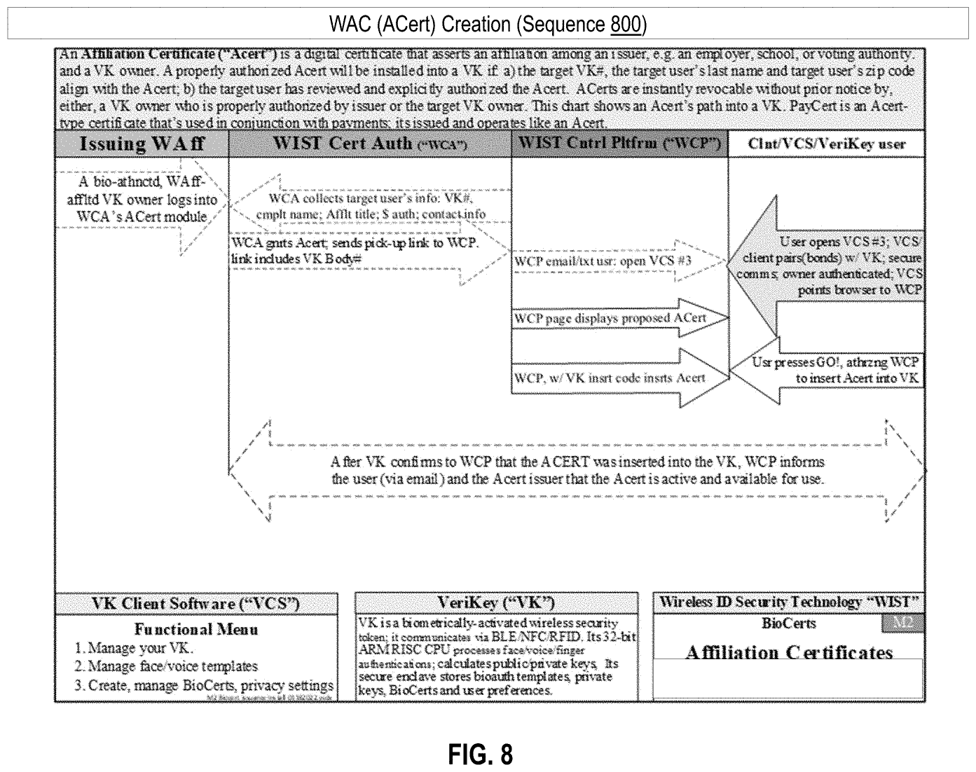

FIG. 8 shows an exemplary sequence 800 for creating an affiliate certificate, in accordance with some embodiments. The sequence 800 may include communication between the VeriKey, user, client device including the VCS, WCA, WCP, and issuing WAff. As shown in FIG. 8, issuance and creation of one or more WACs for storage and/or use by the VeriKey may occur by a WAC generation method (e.g., sequence 800). To issue a WAC to a VeriKey, a WAff may access a system or website associated with and/or operated by the WCA. The WAff may input target user information for the WAC at the WCA, including, for example, name, contact information, and/or title of the target user. The WCA may generate a WAC based on the received target user information. Based on generation of the WAC, the WCA may send the WAC and contact information for the target user to the WCP. Based on receiving the WAC and contact information, the WCP may analyze the contact information for the target user to identify the target user associated with the WAC. The WCP may send a message to the VCS associated with the target user to initiate installation of the WAC based on permission of the target user. The VCS may receive and display the message from the WCP. The user may pair the VeriKey and the VCS as described herein using one or more biometric methods. After pairing, the VCS may display the WAC (and the information contained therein) received from the WCP and a prompt for permission to install the WAC at the VeriKey. The target user may provide an input granting permission to install the WAC at the VeriKey. Based on receiving the input from the user (via the VCS), the WCP may install the WAC at the WIST database of the VeriKey. The VeriKey may send the WCP (via the VCS) a confirmation of installation of the WAC. Based on receiving confirmation of installation from the VeriKey, the WCP may send a message for display at the VCS indicating that the WAC is available for use. The WCP may further send a message to the issuer of the WAC that the WAC is available for use. The sequence 800 may include any suitable combination of steps as described herein and shown with respect to FIG. 8.

### Payment Certificate Creation

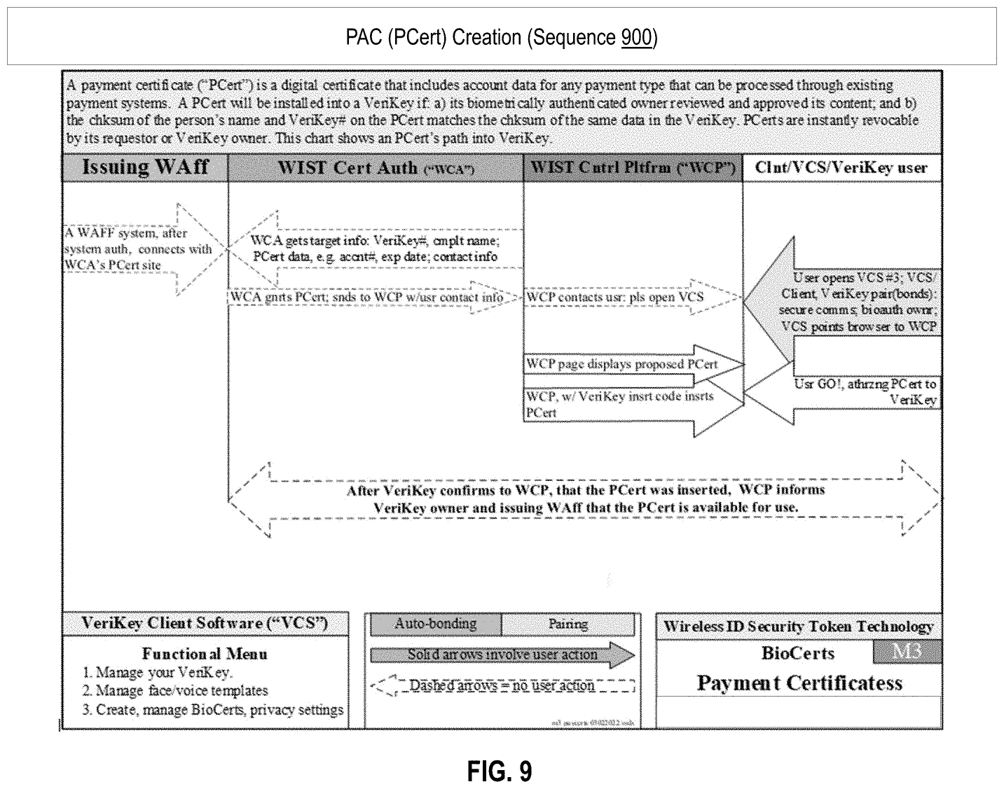

FIG. 9 shows an exemplary sequence 900 for creating a payment certificate, in accordance with some embodiments. The sequence 900 may include communication between the VeriKey, user, client device including the VCS, WCA, WCP, and issuing WAff. In some embodiments, as shown in FIG. 9, issuance and creation of one or more PACs for storage and/or use by the VeriKey may occur by a PAC generation method (e.g., sequence 900). To issue a PAC to a VeriKey, a WAff may access a PAC website associated with the WCA. The WAff may input target user information for the PAC at the WCA, including, for example, name, account number(s), expiration date, PIN(s), and/or contact information. The WCA may generate a PAC based on the received target user information. Based on generation of the PAC, the WCA may send the PAC and contact information for the target user to the WCP. Based on receiving the PAC and contact information, the WCP may analyze the contact information for the target user to identify the target user associated with the PAC. The WCP may send a message to the VCS associated with the target user to initiate installation of the PAC based on permission of the target user. The VCS may receive and display the message from the WCP. The user may pair the VeriKey and the VCS as described herein using one or more biometric methods. After pairing, the VCS may display the PAC (and the information contained therein) received from the WCP and a prompt for permission to install the PAC at the VeriKey. The target user may provide an input granting permission to install the PAC at the VeriKey. Based on receiving the input from the user (via the VCS), the WCP may install the PAC at the WIST database of the VeriKey. The VeriKey may send the WCP (via the VCS) a confirmation of installation of the PAC. Based on receiving confirmation of installation from the VeriKey, the WCP may send a message for display at the VCS indicating that the PAC is available for use. The WCP may further send a message to the issuer of the PAC that the PAC is available for use. The sequence 900 may include any suitable combination of steps as described herein and shown with respect to FIG. 9.

### First Use of a VeriKey at an Affiliate

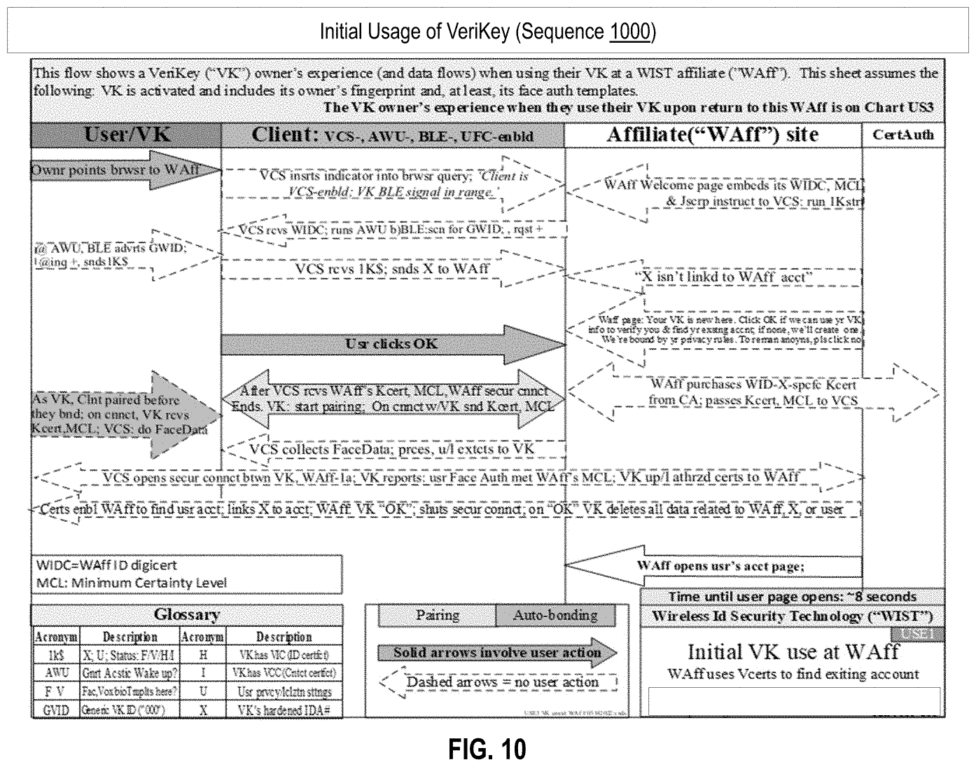

FIG. 10 shows an exemplary sequence 1000 for initial usage of a security token device, in accordance with some embodiments. The sequence 1000 may include communication between the VeriKey, user, client device including the VCS, WCA, and WAff. In some embodiments, as shown in FIG. 10, first use of a VeriKey by a user at a website associated with a WAff may occur according to the following method (e.g., sequence 1000). A user may access a website associated with a WAff (e.g., via a web browser of the client device). The website may send a command to the start the VCS for potential use of a VeriKey. Based on receiving the command, the VCS may generate an acoustic wake-up signal and cause a speaker (or other output device) of the client device to output the acoustic wake-up signal. Based on receiving the command, the VCS may attempt to establish communications with the VeriKey (e.g., via BLE). A microphone (or other sensor) of the VeriKey may detect the acoustic wake-up signal. Based on detecting the acoustic wake-up signal, the VeriKey may send identifier(s) associated with the VeriKey to the VCS (e.g., via BLE). In certain embodiments, VeriKeys send the same generic identifier upon hearing the acoustic wake up signal. Then, if the VeriKey receives a request for more information, it sends a suite of data that is specific for this VeriKey, (i.e., its ID #, the checksums of its VUIC (ID) and VUCC (contact info), face authentication and/or voice authentication data).

The VCS may receive the identifier(s) and send the identifier(s) to the website to determine whether the VeriKey has been used previously to login at the website. The website may receive the identifier(s) and compare the identifier(s) to a VeriKey database (e.g., corresponding to the WCA) to determine whether the VeriKey has been used to log in at the website. The website may determine the VeriKey has not been used previously to login at the website. The website may display a prompt instructing a user to select a login method. For example, the website may display a prompt instructing the user to select login by a VeriKey or by a username/password combination. The user may select the VeriKey login method at the website (e.g., via the VCS). Based on receiving a selection of the VeriKey login method, the website may display a prompt, where the prompt requests use of the user's VeriKey information. The user may grant use of the VeriKey information to the website. Based on receiving the grant from the user, the website may send an indication of grant to the VCS of the client device to initiate pairing with the VeriKey. Based on pairing, the VCS may establish secure communications between the VeriKey and the website (acting as a proxy). The website may send a key certificate to the VeriKey via the client device. Based on receiving the key certificate from the website, the VeriKey may compute one or more public and/or private keys, store the private key(s), and send the public key(s) to the website via the client device. The VCS may prompt the user to input biometric information to proceed with VeriKey information use at the website. Based on receiving a biometric input (e.g., fingerprint input) at the VeriKey or client device (e.g., facial input or voice input), the VeriKey may compare the received biometric input to the corresponding biometric authentication template to verify the user's identity. Based on meeting or exceeding the minimum certainty threshold of the biometric template, the VeriKey may send one or more biometrically-authenticated certificates (e.g., a VUIC, VUCC(s), PAC(s), WAC(s), etc.) to the website. The one or biometrically-authenticated certificates sent to the website may be determined based on a user's privacy settings in the WIST database and/or based on access configuration settings for the website determined by the WCP. Using the information from the received biometrically-authenticated certificate(s), the website may access an account associated with the user or, if an account does not exist, the website may create an account based on the information. After accessing and/or creating the account, the website may open an account page associated with the user. The sequence 1000 may include any suitable combination of steps as described herein and shown with respect to FIG. 10.

### Return Use of a VeriKey at an Affiliate

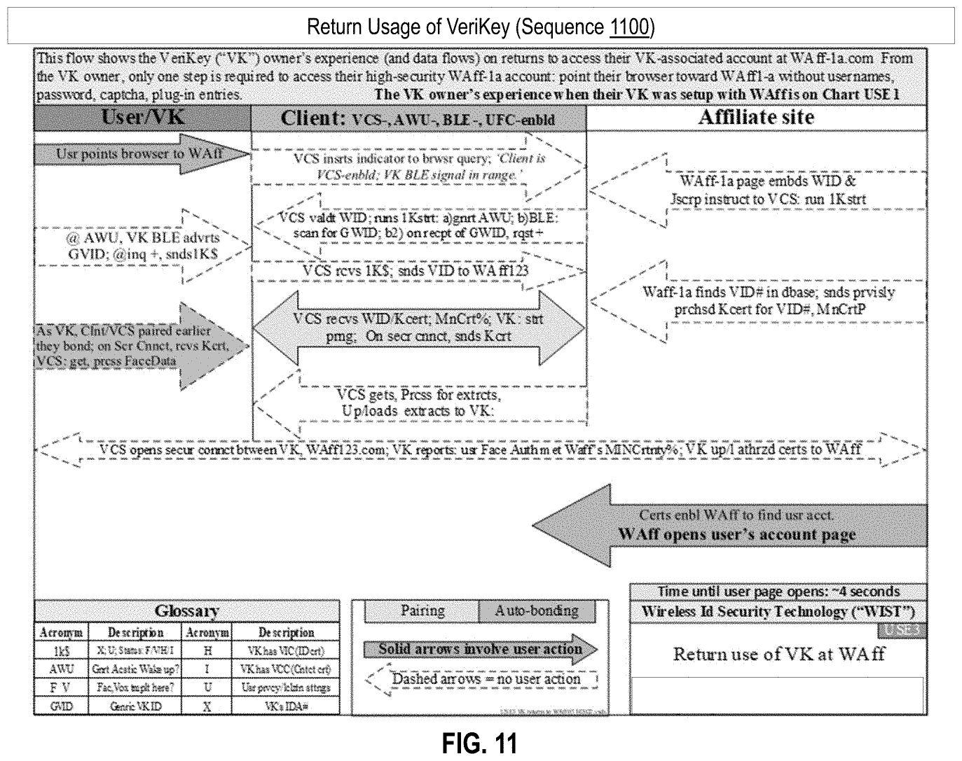

FIG. 11 shows an exemplary sequence 1100 for return usage of a security token device, in accordance with some embodiments. The sequence 1100 may include communication between the VeriKey, user, client device including the VCS, WCA, and WAff. In some embodiments, as shown in FIG. 11, return use of a VeriKey by a user at a website associated with a WAff may occur according to the following method (e.g., sequence 1100). A user may access a website associated with a WAff (e.g., via a web browser of the client device). The website may send a command to the start the VCS for potential use of a VeriKey. Based on receiving the command, the VCS may generate an acoustic wake-up signal and cause a speaker of the client device to output the acoustic wake-up signal. Based on receiving the command, the VCS may attempt to establish communications with the VeriKey (e.g., via BLE). A microphone (or other sensor) of the VeriKey may detect the acoustic wake-up signal, causing the VeriKey to send identifier(s) associated with the VeriKey to the VCS. The VCS may receive the identifier(s) and send the identifier(s) to the website to determine whether the VeriKey has been used previously to login at the website. The website may receive the identifier(s) and compare the identifier(s) to a VeriKey database to determine whether the VeriKey has been used to log in at the website. The website may determine the VeriKey has been used previously to login at the website. The website may send a command to the VCS requesting a biometric input from the user to authenticate the user's identity. The VCS may display a prompt requesting a user to input biometric information. The user may input biometric information as described herein, causing the VeriKey to compare the received biometric input to the corresponding biometric authentication template to verify the user's identity. Based on meeting or exceeding the minimum certainty threshold of the biometric template, the VeriKey may send WAC(s) associated with the website to the VCS. The VCS may send the received WAC(s) to the website. Based on receiving the WAC(s), the website may determine whether the received WAC(s) correspond to user information stored by the website. Based on validating the received WAC(s) as corresponding to user information stored by the website, the website may open an account page associated with the user. The sequence 1100 may include any suitable combination of steps as described herein and shown with respect to FIG. 11.

### BAVIT Architecture

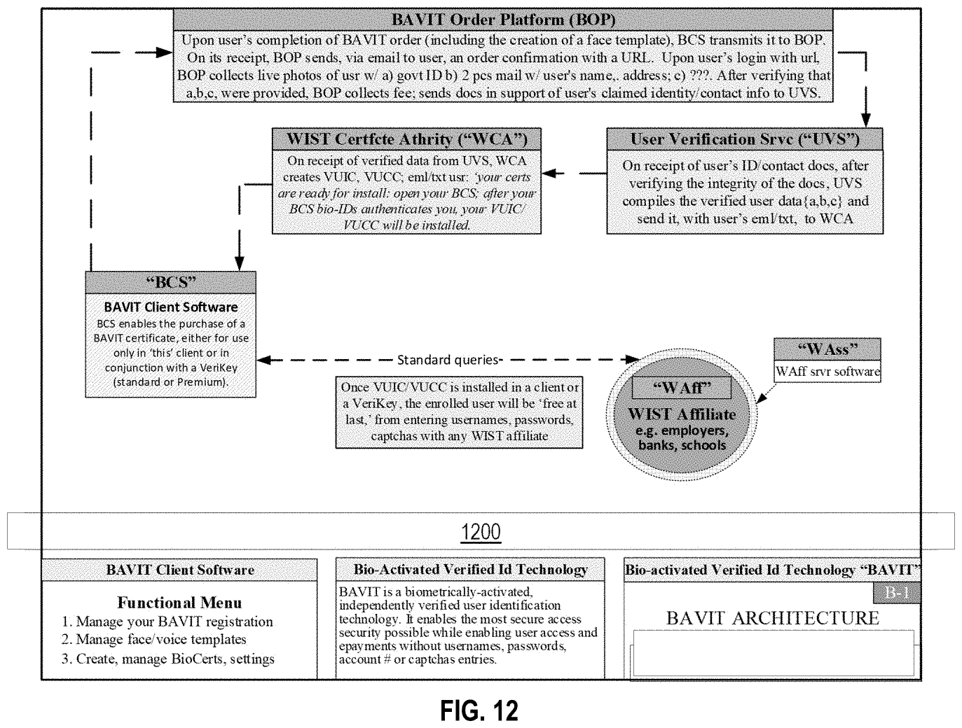

FIG. 12 shows an illustration of an exemplary system 1200 for using a verified user identity certificate, in accordance with some embodiments. The system 1200 incorporates biometrically-activated verified identification technology (referred to as “BAVIT”) corresponding to use of a VUIC and/or a VUCC as described herein. The system 1200 may include one or more WAss corresponding to one or more WAffs. The system 1200 may include BAVIT client software (referred to as “BCS”) included in a client device (e.g., as described above), where the BCS enables a user to acquire (e.g., purchase) one or more digital certificates and/or biometric templates for storage in a secure enclave of a VeriKey and/or a client device and later use with a WAff. In some cases, BCS may be equivalent to and/or include one or more features of VCS as described herein. The BCS may communicate with a BAVIT order platform, one or more WAss, and/or a WCA. The system 1200 may include a WCA, which may create and/or generate digital certificates (e.g., VUICs and/or VUCCs) as described herein and may send the digital certificates for use with a VeriKey and/or client device as described with respect to FIG. 7A-7B. The WCA may communicate with the BCS and the UVS. The system 1200 may include UVS including one or more features as described herein to verify identifying information for a user of a VeriKey and/or client device including BCS. The UVS may communicate with the WCA and a BAVIT order platform. In some cases, the system 1200 may include a BAVIT order platform (referred to as “BOP”). The BOP may receive orders from the BCS, may send one or more prompts to the BCS for display, and/or may receive identifying information from a user. In some cases, the BOP may send the identifying information to the UVS for verification. The system 1200 may include one or more additional features as shown in FIG. 12.

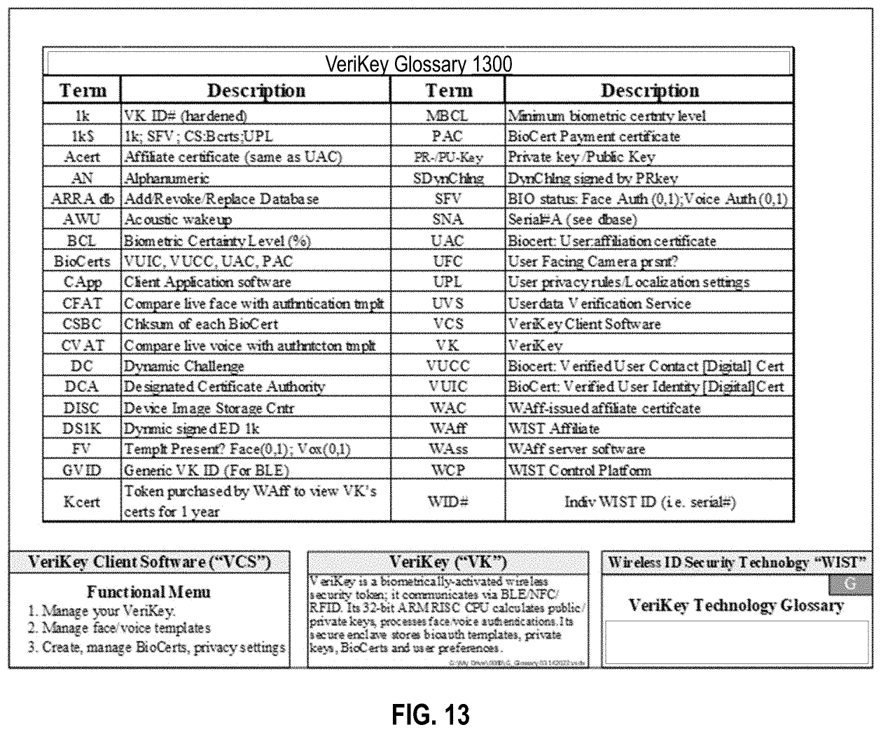

FIG. 13 shows a glossary 1300 corresponding to the security token device, in accordance with some embodiments. The terminology described in the glossary 1300 may apply to any of the terminology described herein and described with respect to FIGS. 1-12.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or other non-transitory storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The techniques and system architecture described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for generating a verified user identity certificate (VUIC) for use by a security token device, the method comprising:
receiving, at an application of a client device, a user input to initiate creation of the VUIC;
generating for display, via the application, a prompt to authenticate the user via a first fingerprint input at the security token device;
pairing, based on a first authentication of the first fingerprint input, the security token device and the client device;
receiving, at the client device, a user input comprising identity information associated with the user;
sending, from the client device, the identity information to a third-party verification service;
generating, based on a verification of the identity information, the VUIC, wherein the VUIC comprises: a name, date of birth, and social security number;
generating for display, via the application, a prompt to initiate installation of the VUIC at the security token device;
receiving, based on a second authentication of a second fingerprint input and a user input authorizing installation of the VUIC at the security token device, at least one security key from the security token device; and
installing the VUIC at a secure enclave of the security token device.

2. The method of claim 1, further comprising:
generating for display, via the application, one or more requirements to initiate creation of the VUIC.

3. The method of claim 2, further comprising:
receiving, at the application of the client device, a user input acknowledging the one or more requirements; and
initiating pairing, based on the user input acknowledging the one or more requirements, the security token device and the client device.

4. The method of claim 3, wherein generating for display the prompt to authenticate the user via the first fingerprint input at the security token device is based on the user input acknowledging the one or more requirements.

5. The method of claim 1, wherein the first authentication of the first fingerprint input comprises:
receiving, at the security token device, the first fingerprint input; and
determining, based on a comparison of the first fingerprint input to a fingerprint template stored by the security token device, the fingerprint template as corresponding to the user.

6. The method of claim 1, further comprising:
generating for display, via the application, a prompt for the identity information associated with the user.

7. The method of claim 1, wherein the identity information associated with the user comprises one or more of: user contact information, government-issued identification documentation, and a photo of the user.

8. The method of claim 1, further comprising:
receiving, at the client device, confirmation of a receipt of the identity information from the third-party verification service.

9. The method of claim 1, further comprising:
receiving, at the application of the client device, contents of the VUIC; and
sending, based on a user input accepting the contents of the VUIC, the user input authorizing installation of the VUIC at the security token device.

10. The method of claim 1, further comprising:
receiving, from a certificate authority via the client device, the VUIC.

11. A system comprising:
one or more computer systems programmed to perform operations comprising:
receiving, at an application of a client device, a user input to initiate creation of a verified user identity certificate (VUIC);
generating for display, via the application, a prompt to authenticate the user via a first fingerprint input at the security token device;
pairing, based on a first authentication of the first fingerprint input, the security token device and the client device;
receiving, at the client device, a user input comprising identity information associated with the user;
sending, from the client device, the identity information to a third-party verification service;
generating, based on a verification of the identity information, the VUIC, wherein the VUIC comprises: a name, date of birth, and social security number;
generating for display, via the application, a prompt to initiate installation of the VUIC at the security token device;
receiving, based on a second authentication of a second fingerprint input and a user input authorizing installation of the VUIC at the security token device, at least one security key from the security token device; and
installing the VUIC at a secure enclave of the security token device.

12. The system of claim 11, wherein the operations further comprise:
generating for display, via the application, one or more requirements to initiate creation of the VUIC.

13. The system of claim 12, wherein the operations further comprise:
receiving, at the application of the client device, a user input acknowledging the one or more requirements; and
initiating pairing, based on the user input acknowledging the one or more requirements, the security token device and the client device.

14. The system of claim 13, wherein generating for display the prompt to authenticate the user via the first fingerprint input at the security token device is based on the user input acknowledging the one or more requirements.

15. The system of claim 11, wherein the first authentication of the first fingerprint input comprises:
receiving, at the security token device, the first fingerprint input; and
determining, based on a comparison of the first fingerprint input to a fingerprint template stored by the security token device, the fingerprint template as corresponding to the user.

16. The system of claim 11, wherein the operations further comprise:
generating for display, via the application, a prompt for the identity information associated with the user.

17. The system of claim 11, wherein the identity information associated with the user comprises one or more of: user contact information, government-issued identification documentation, and a photo of the user.

18. The system of claim 11, wherein the operations further comprise:
receiving, at the client device, confirmation of a receipt of the identity information from the third-party verification service.

19. The system of claim 11, wherein the operations further comprise:
receiving, at the application of the client device, contents of the VUIC; and
sending, based on a user input accepting the contents of the VUIC, the user input authorizing installation of the VUIC at the security token device.

20. The system of claim 11, wherein the operations further comprise:
receiving, from a certificate authority via the client device, the VUIC.
